(19) United States
(12) Patent Application Publication
(10) Pub. No.: US 2014/0181768 A1
(43) Pub. Date: Jun. 26, 2014

(54) AUTOMATED PERFORMANCE VERIFICATION FOR INTEGRATED CIRCUIT DESIGN

(71) Applicant: Advanced Micro Devices, Inc., Sunnyvale, CA (US)

(72) Inventors: Jian Yang, Shanghai (CN); Pingping Shao, Cupertino, CA (US); Houkun Li, San Diego, CA (US); Jerry Su, Shanghai (CN); Chi Tang, Shanghai (CN); Griffin Wang, Shanghai (CN)

(21) Appl. No.: 13/723,279

(22) Filed: Dec. 21, 2012

(51) Int. Cl. G06F 17/50

(52) U.S. Cl. CPC G06F 17/5081
USPC 716/107

(57) ABSTRACT

A method and apparatus for automated performance verification for integrated circuit design is described herein. The method includes test preparation and automated verification stages. The test preparation stage generates design feature-specific performance tests to meet expected performance goals under certain workloads using optimization approaches and for different design configurations. The automated verification stage is implemented by integrating functional, automated modules into a verification infrastructure. These modules include register transfer level (RTL) simulation, performance evaluation and performance publish modules. The RTL simulation module schedules performance testing jobs, runs a series of performance tests on simulation logic simultaneously and generates performance counters for each functional unit. The performance evaluation module consists of three sub-functions including a functional comparison between actual results and a reference file containing the expected results, performance measurements for throughput, execution time, and latency values, and performance analysis. The performance publish module publishes performance results and analysis reports.

### TECHNICAL FIELD

The disclosed embodiments are generally directed to automated performance verification in integrated circuit design.

### BACKGROUND

Digital integrated circuit (IC) design generally consists of electronic system level (ESL) design, register transfer logic (RTL) design and physical design. The ESL design step creates a user functional specification that is converted in the RTL design step into an RTL description. The RTL describes, for example, the behavior of the digital circuits on the chip. The physical design step takes the RTL along with a library of available logic gates, and generates a chip design.

The RTL design step is where functional verification is performed. As noted above, the user functional specification is translated into hundreds of pages of detailed text and thousands of lines of computer code. All potential paths need to be performance verified. However, arbitrary decisions on performance evaluation are usually made in the verification process. The verification tools are randomly selected and not systematic. Moreover, in some situations, hand operated procedures are often used to schedule jobs manually to fulfill verification tasks. This requires tracking the task executing process and trying to run one task after another. As intimated, this generates gaps between two consecutive tasks as the tasks are not running continuously. All of this leads to a limited number of executed verification steps from which minimal performance data can be extracted. It therefore becomes difficult to analyze the actual performance of a system.

### SUMMARY OF EMBODIMENTS

A method and apparatus for automated performance verification for integrated circuit design is described herein. In some embodiments, the method includes a test preparation stage and an automated verification stage. The test preparation stage generates design feature-specific performance tests to meet expected performance goals under certain workloads using a variety of optimization approaches and for different design configurations. The automated verification stage is implemented by integrating three functional, automated modules into a verification infrastructure. These modules include a register transfer level (RTL) simulation module, a performance evaluation module and a performance publish module. The RTL simulation module schedules performance testing jobs, runs a series of performance tests on simulation logic nearly simultaneously and generates performance counters for each functional unit. The performance evaluation module consists of three sub-functions including a functional comparison between actual results and a reference file containing the expected results, performance measurements for throughput, execution time, latency values and the like, and performance analysis. The performance publish module generates and publishes performance results and analysis reports, for example, onto a web page or into a database.

### BRIEF DESCRIPTION OF THE DRAWINGS

A more detailed understanding may be had from the following description, given by way of example in conjunction with the accompanying drawings wherein:

FIG. 1 is an example flowchart of an automated performance verification method in accordance with some embodiments;

FIG. 2 is an example flowchart of a test preparation stage of an automated performance verification method in accordance with some embodiments;

FIG. 3 is an example flowchart of an automated verification stage of an automated performance verification method in accordance with some embodiments;

FIG. 4 is an example flowchart of a performance evaluation stage of an automated performance verification method in accordance with some embodiments;

FIG. 5 is an example flowchart of one group verification task which comprises some test verification tasks in an automated performance verification method in accordance with some embodiments;

FIG. 6 is an example flowchart of a performance pass rule of an automated performance verification method in accordance with some embodiments;

FIG. 7 is an example flowchart of an automated verification infrastructure of an automated performance verification method in accordance with some embodiments;

FIG. 8 is an example graphical display of performance data from an automated performance verification method in accordance with some embodiments; and

FIG. 9 is a block diagram of an example device in which one or more disclosed embodiments may be implemented in accordance with some embodiments.

### DETAILED DESCRIPTION

Described herein is a method and apparatus for automated performance verification for integrated circuit design. In some embodiments, the method includes a test preparation stage and an automated verification stage. The test preparation stage generates design feature-specific performance tests to meet expected performance goals under certain workloads using a variety of optimization approaches and for different design configurations. The automated verification stage is implemented by integrating three functional, automated modules into a verification infrastructure. These modules include a register transfer level (RTL) simulation module, a performance evaluation module and a performance publish module. The RTL simulation module schedules performance testing jobs, runs a series of performance tests on simulation logic nearly simultaneously and generates performance counters for each functional unit. The performance evaluation module consists of three sub-functions including a functional comparison between actual results and a reference file containing the expected results, performance measurements for throughput, execution time, latency values and the like, and performance analysis. The performance publish module generates and publishes performance results and analysis reports, for example, onto a web page or into a database.

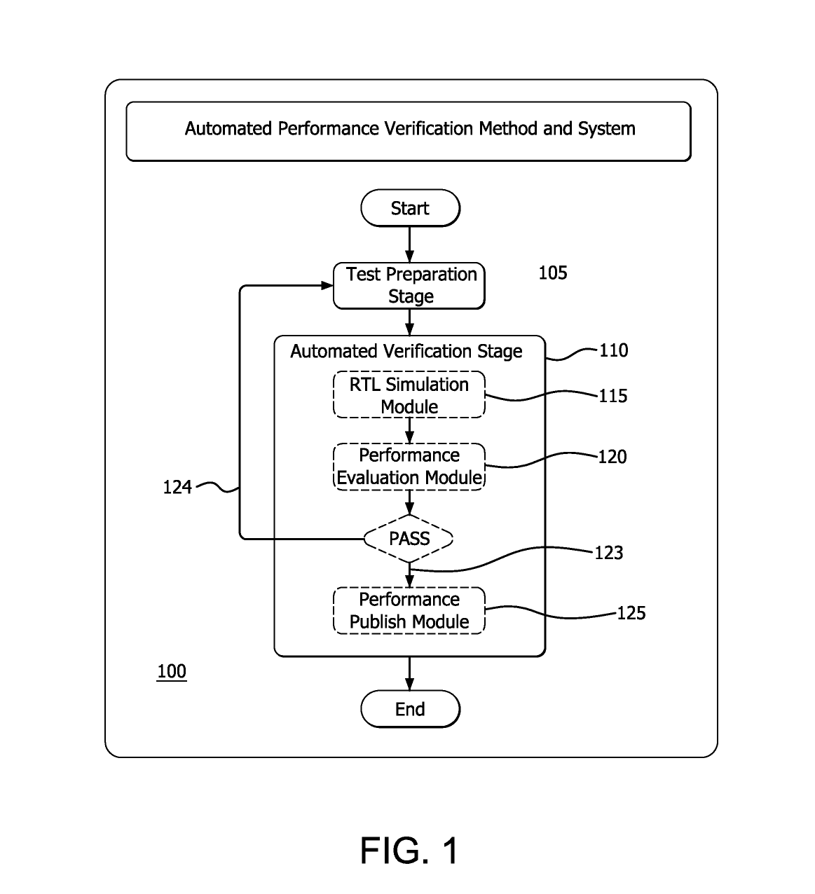

FIG. 1 is an example top level flowchart of an automated performance verification method 100 in accordance with some embodiments. The method 100 may operate at the unit level, where the unit refers to, for example but is not limited to, a sub-circuit, a pathway, a functional portion and the like of an integrated circuit (IC) design. For a given unit under test, a test preparation stage 105 is executed to design feature-specific performance tests based on the expected performance goals of the unit. These tests account for workload, optimization approaches and design configurations.

An automated verification stage 110 uses the performance tests to verify the functionality of the unit. This verification process is implemented by integrating three consecutive functional modules into a verification infrastructure. All three modules are fully automated so that there are no gaps in timing in the testing. The functional modules include an RTL simulation module 115 which does the actual testing and passes the results to a performance evaluation module 120. If the performance evaluation module 120 determines that the unit has met expectations (123), then the performance results will be sent to a performance publish module 125 which will publish and present the performance results in tabular and graphical formats on a web page or in a database. If the performance evaluation fails (124), the process starts over again at the test preparation stage 105. For example, this may include debugging the unit, adjusting the performance tests and then retesting the unit.

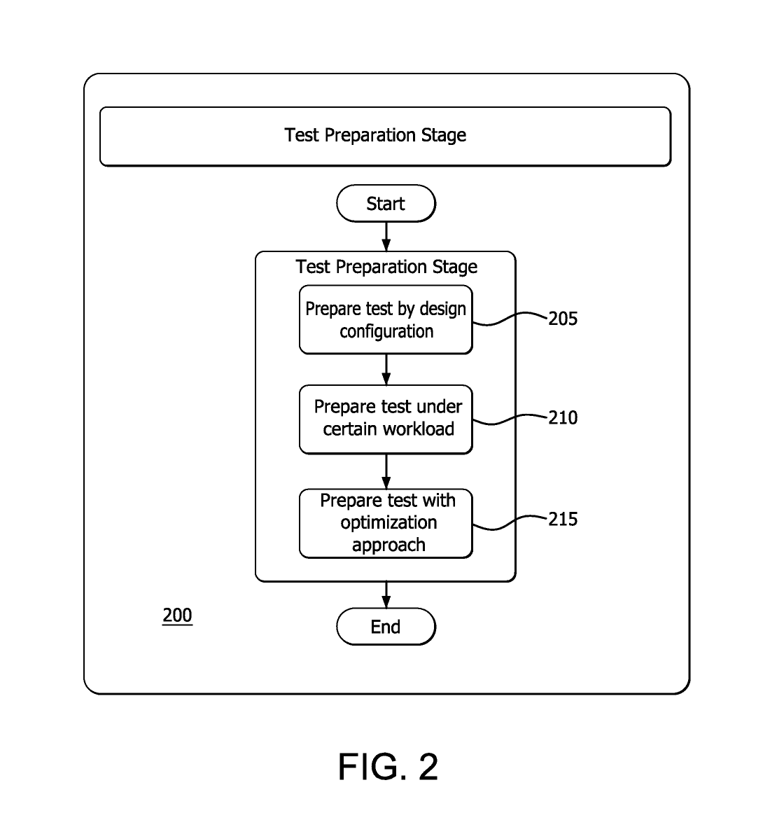

FIG. 2 is an example flowchart of a test preparation stage 200 of the automated performance verification method 100 in accordance with some embodiments. The test preparation stage 200 initially prepares performance tests based on a specific design configuration (205). As noted above, the unit may represent a portion of the IC. The IC design may be in one of many design configurations or versions and has to be accounted for in the generation of the performance tests. Different design versions will have different expectations and different performance goals of one unit and ultimately the IC. For example, different registers may be set and used in different design versions or configurations for the same processing. In another example, a unit or function may exist in one design version but does not exist in another design version. In yet another example, a function may go through different data paths in different design versions.

The test preparation stage 200 also needs to account for specified workload conditions as performance requirements or expectations will vary depending on the activity level of the unit, the size of the unit or the size of the IC (210). For example, under certain scenarios, the performance tests may need to have minimum workloads to hide instruction latency issues. Improper workload adjustments will skew the results in the wrong direction. In another example, the workload may need to be adjusted to obtain a reasonable RTL simulation time in certain design versions while guaranteeing an expected performance measurement window at the same time. It may also be necessary to evenly distribute the workload to a number of function units which are different in design versions so that accurate performance data may be obtained. The performance tests are updated and revised automatically based on actual performance and analysis and are fine tuned using the automated verification system. This increases reliability and increases the value of the performance analysis of the data.

The performance tests may also be optimized to improve and match the performance requirements (215). These optimization techniques may include, but are not limited to, padding a hull shader to avoid local data storage bank conflicts, address alignment, not allowing a Shader seQuence Cache (SQC) request to split a cache, avoid having a primitive being sent to two shader engines, warming a cache for tests with virtual memory settings, and properly setting a memory channel mapping register for different kinds of memory clients to avoid unexpected remote memory requests with very long latency. These optimizations assist in distinguishing whether a performance issue is software setting related or hardware design related. These optimizations are updated and revised based on actual performance and analysis and are fine tuned using the automated verification system.

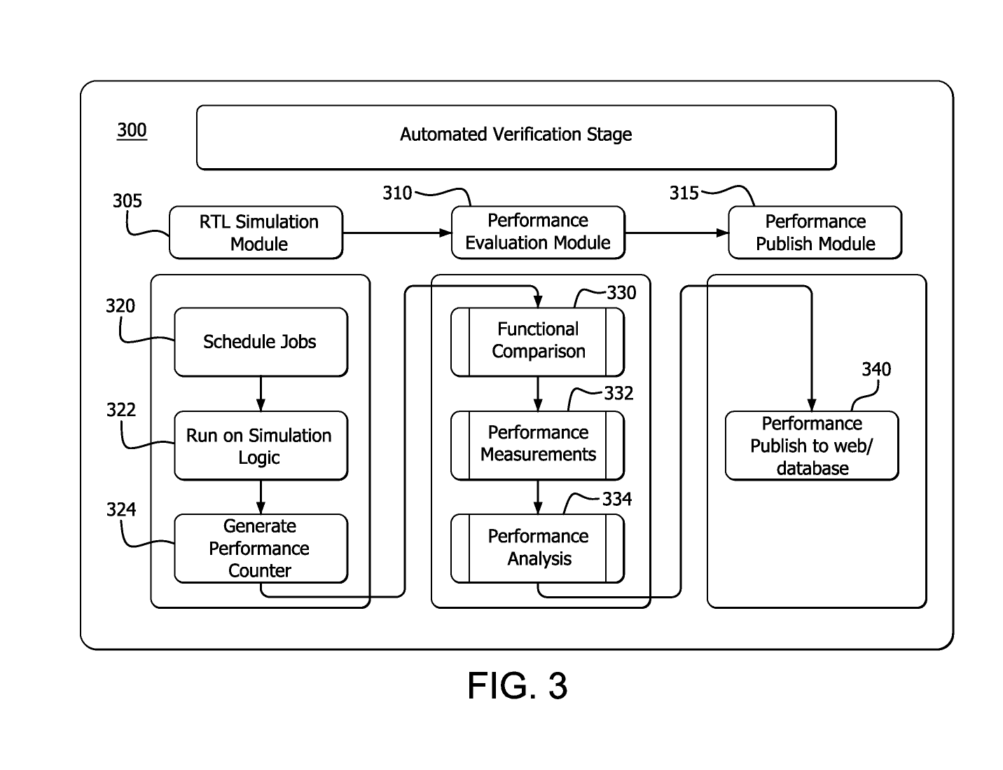

FIG. 3 is an example flowchart of an automated verification stage 300 of an automated performance verification method 100 in accordance with some embodiments. As stated hereinabove, the automated verification stage 300 includes an RTL simulation module 305, a performance evaluation module 310 and a performance publish module 315. The RTL simulation module 305 schedules performance testing jobs for the unit(s) (320), runs a series of performance tests on the simulation logic, (nearly simultaneously), (322) and generates performance counters for each functional unit (324).

The performance evaluation module 310 receives the results from the RTL simulation module 305 and performs a functional comparison between the actual results and a reference file containing the expected results (330). The performance evaluation module 310 then determines performance measurements for throughput, execution time, latency values and other measurement parameters (332) and performs a performance analysis on the performance measurements (334). The analysis from the performance evaluation module 310 are sent to the performance publish module 310, which publishes the performance results and analysis report (340).

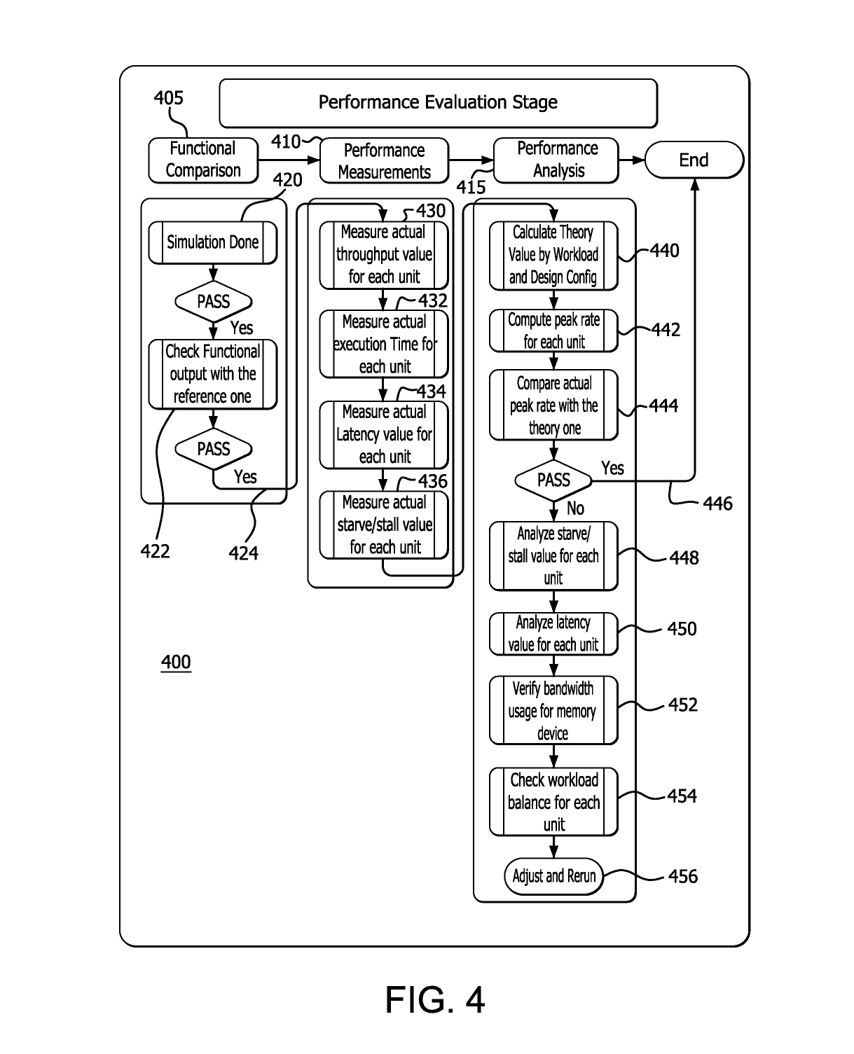

FIG. 4 is an example flowchart of a performance evaluation stage 400 of an automated performance verification method 100 in accordance with some embodiments. At a top level, the performance evaluation stage 400 consists of three consecutive flows, a functional comparison module 405, a performance measurements module 410 and a performance analysis module 415.

The functional comparison module 405 determines, (on a rolling basis), if the simulation run is done for the unit (420). If the simulation run is done, then the functional comparison module 405 compares the actual output results with a reference to determine whether the functional behavior of the unit meets expectations (422). If the unit's functional behavior meets expectations (424), then the flow continues to the performance measurements module 410. If the functional behavior does not pass, then the process starts over again at the test preparation stage 105 in FIG. 1. For example, this may include debugging the unit, adjusting the performance tests and then retesting the unit.

The performance measurements module 410 collects or extracts performance measurement data for the completed simulation run for each unit. It is much easier and clearer to analyze the performance data after extracting all comprehensive performance data systematically from the various performance counters generated by the RTL simulation. The comprehensive and valuable performance data generated by the performance tools include, but are not limited to, throughput, execution time, register settings for correct design configuration, latency information for memory devices, starve/stall values or workload balance values per each working unit. For example, the data collected may include, but is not limited to, throughput data (430), execution time information (432), latency information (434), starve/stall values (436) and other performance parameters. This information is then used by the performance analysis module 415. The analysis from these modules are automatically fed back to the performance test generation modules to increase the overall reliability and value of the performance data.

The performance analysis module 415 calculates the theoretical peak rate, compares it with the measured data and analyzes the difference between them. This includes calculating a theoretical peak rate value (440), computing an actual peak rate data (442) and performing a comparison between the theoretical and actual numbers (444). If unit's peak rate performance passes (446), then the test has been successfully completed and the process flows to the performance publish module 125 in FIG. 1.

If the unit did not meet the desired or expected peak rate (448), the performance analysis module 415 analyzes the data to identify the bottleneck. This analysis may include analyzing the starve/stall value for each unit (450), analyzing the latency information (452), verifying the bandwidth usage for memory devices (454) and checking workload balance for each unit (456). After the analysis is complete, the flow returns to the test preparation stage 105 in FIG. 1. For example, this may include debugging the unit, adjusting the performance tests and then retesting the unit.

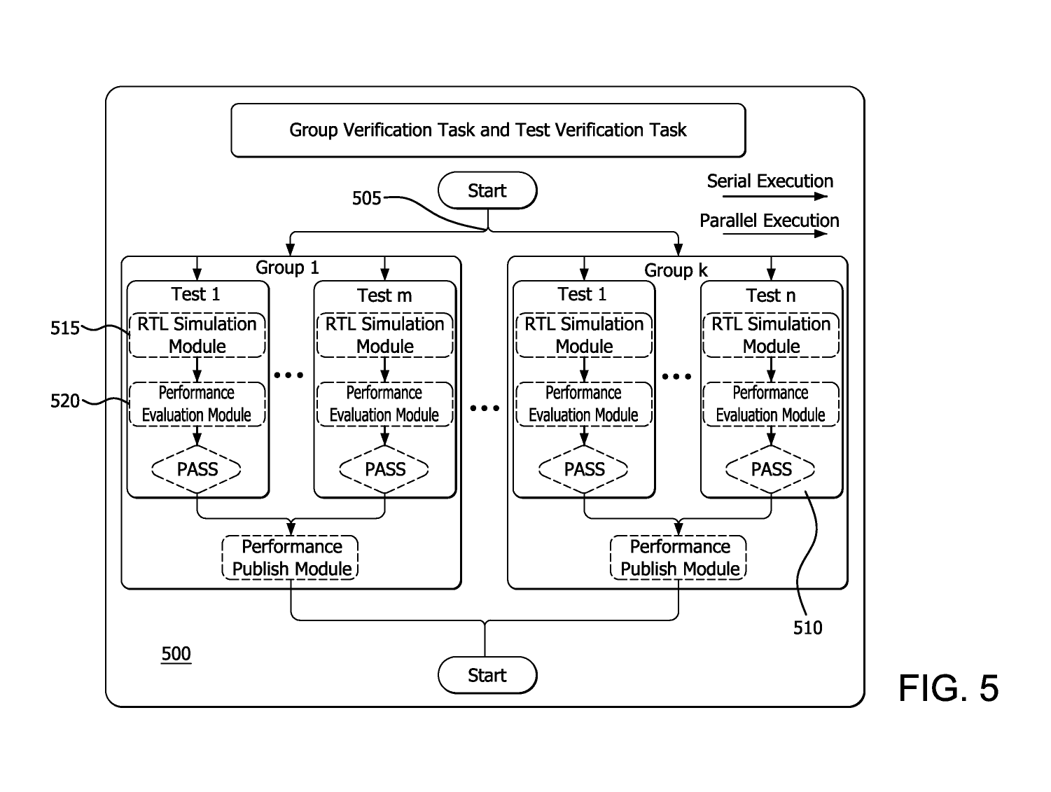

FIG. 5 is an example flowchart 500 of group verification tasks 505 and test verification tasks 510 in an automated performance verification method in accordance with some embodiments. Test verification tasks 510 are the tasks that run internally within a test, for example, Test 1 . . . Test m, and for example, are the RTL Simulation Module 515 and the Performance Evaluation Module 520. The test verification tasks 510 run serially and there is no extra execution time wasted between any consecutive tasks.

Group verification tasks 505 are tasks that run multiple tests in parallel for a unit. The group verification tasks 505 may include the test verification tasks 510. Group verification tasks 505 are scheduled once and will be executed simultaneously. There will also be no extra execution time wasted between any group verification tasks 505 as they are running in parallel. The verification infrastructure is similar to an Integrated Development Environment which provides comprehensive facilities for creating verification systems. All verification tasks are integrated into the verification infrastructure as a single flow to make sure that all the required tasks are executed continuously one after another. The automated performance verification method is fast in both group verification tasks 505 and test verification tasks 510 as all the verification tasks are running continuously under the automated verification system.

The problems in verification systems include a lack of a systematic verification method. This leads to limited coverage of verification steps and extraction of limited valuable performance data. Another problem is that most verification systems are manual operation intensive requiring a greater workforce for surveillance of the task executing process. It also requires extra execution time to finish identical jobs that are manually operated. Personnel need to manually run tasks one after another. This generates gaps between two consecutive tasks because they are not running continuously and extra execution time is needed to finish the verification work and more personnel is required to engage in the verification process. Practical verification results show that at least one more extra hour will be consumed per each test under existing verification processes and this amplified when running massive verification tasks with more than 3,000 tests. As stated herein, a systematic verification method for the verification system improves the overall work efficiency and allows greater contributions to a project by fewer team members.

Moreover, these manually operated verification methods have limitations in the scope of coverage with respect to performance verification and analysis. For example, arbitrary decisions on performance evaluation may be made in the verification process due to manual operations. The verification tools are randomly selected and not systematic. This leads to limited coverage as all or some verification steps are not executed. This in turn limits or decreases the amount of valuable performance data that is available or could be extracted. Analysis of a limited set of performance data provides little or no basis for measuring performance in view of expectations.

The automated verification system as described herein may save 1-3 personnel on the verification work for each project as all the necessary verification tasks can be submitted once, run on simulation logic simultaneously and be finished and evaluated automatically without surveillance. Practical verification experiences show that at least one hour could be saved per each test during the verification process. This savings is amplified running massive verification tasks with more than 3,000 tests.

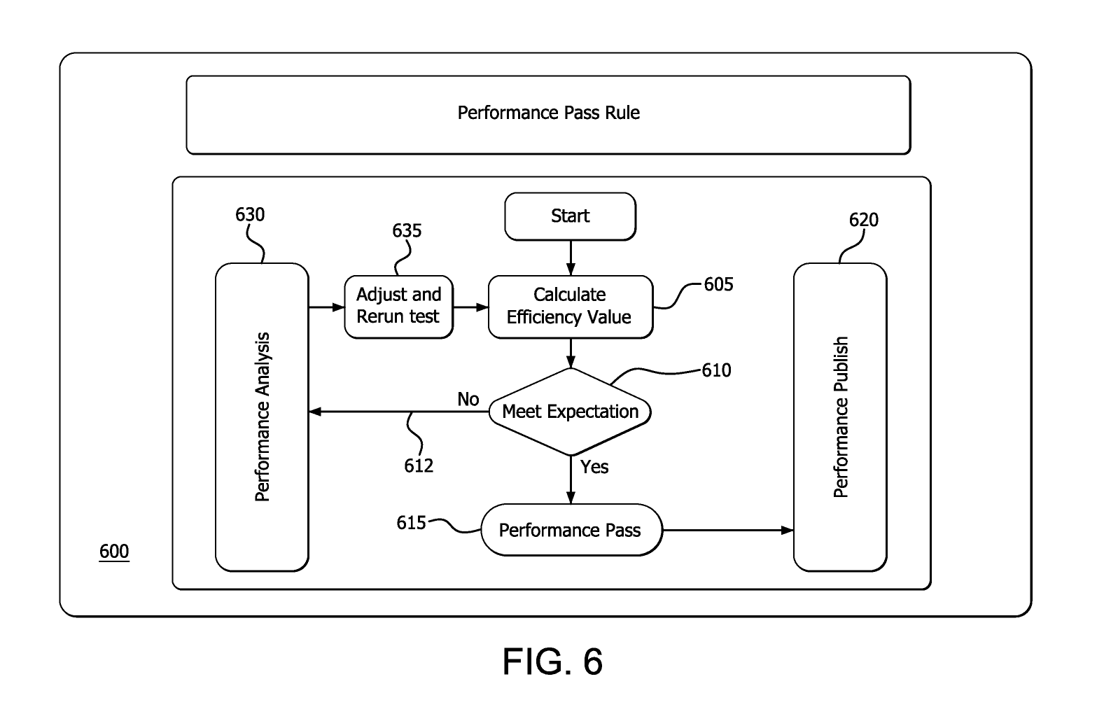

FIG. 6 is an example flowchart of a performance pass rule 600 of an automated performance verification method in accordance with some embodiments. The performance pass rule determines an achieved efficiency value by dividing the actual performance value by a theory value (605). The actual performance value is measured after running the RTL simulation and the theory performance value is calculated based on the design configurations, and workload as described herein. Any of the performance measures described herein may be used. If the achieved efficiency value meets expectations (610), the test is marked as pass (615), and the performance results are sent to the performance publish module 620. If the efficiency does not meet expectations (612), the performance analysis module 630 is executed using the comprehensive performance data extracted from a performance measurement module, (as shown in FIG. 4). The performance test may need to be adjusted and the test rerun (635). Examples of the performance pass rule 600 as implemented are shown, for example, in FIGS. 4 and 5. In particular, performance pass rule 600 is implemented as the compare actual peak rate with theory one 444 and pass 446 in FIG. 4 and as part of the performance evaluation module and pass blocks in FIG. 5.

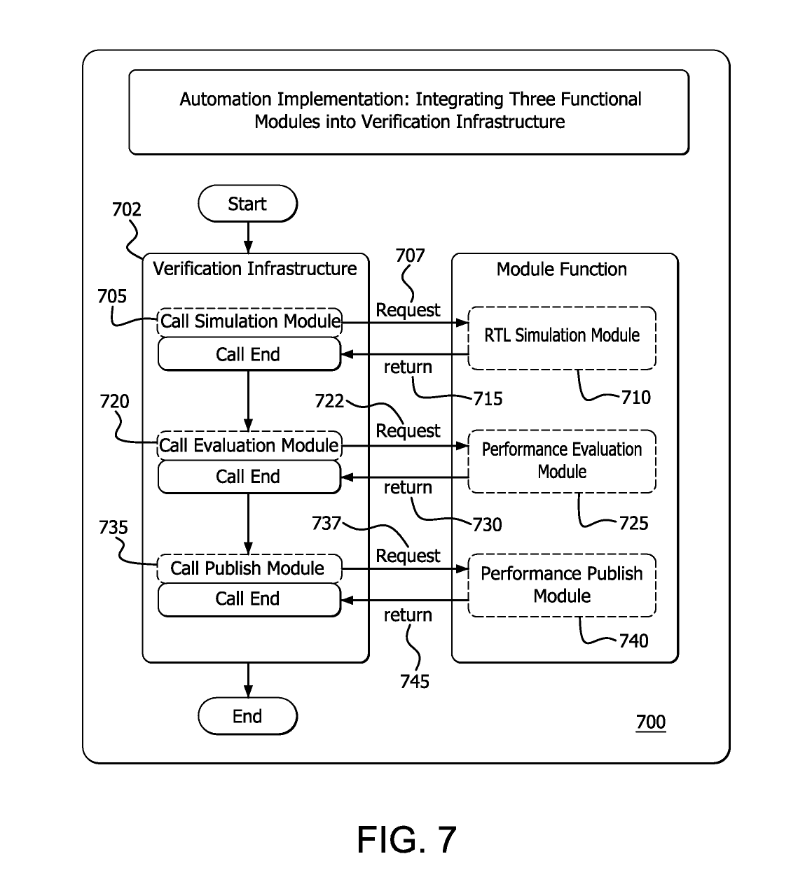

FIG. 7 is an example flowchart of an automated verification infrastructure 700 of an automated performance verification method in accordance with some embodiments. As described herein, the automated performance verification method is achieved by integrating three functional modules into the verification infrastructure 700 as a single working flow. The verification infrastructure 700 provides comprehensive facilities for creating a verification system. All verification tasks are integrated into the verification infrastructure 700 as a single flow to make sure that all tasks are executed continuously one after another.

All test verification tasks are scheduled in an executing queue 702 and run one by one. If a task reaches a call simulation module task 705, an execution request 707 is sent to the RTL simulation module 710. The RTL simulation module 710 executes and returns the results back to the execution queue 702 when the simulation function is complete (715). The next task is then executed. For example, the call evaluation module task 720 sends an execution request 722 to the performance evaluation module 725. The performance evaluation module 725 executes and returns the results back to the execution queue 702 when the evaluation function is complete (730). The process repeats for the publish module 740. In particular, the call publish module task 735 sends an execution request 737 to the publish module 740. The publish module 740 executes and returns the results back to the execution queue 702 when the publish function is complete (745).

As described hereinabove, the performance results are illustrated using tables and figures and are published on a web page or written into a database. It is easy for a system architect to review the overall performance of the system or for a marketing engineer to show the performance of the product to the public.

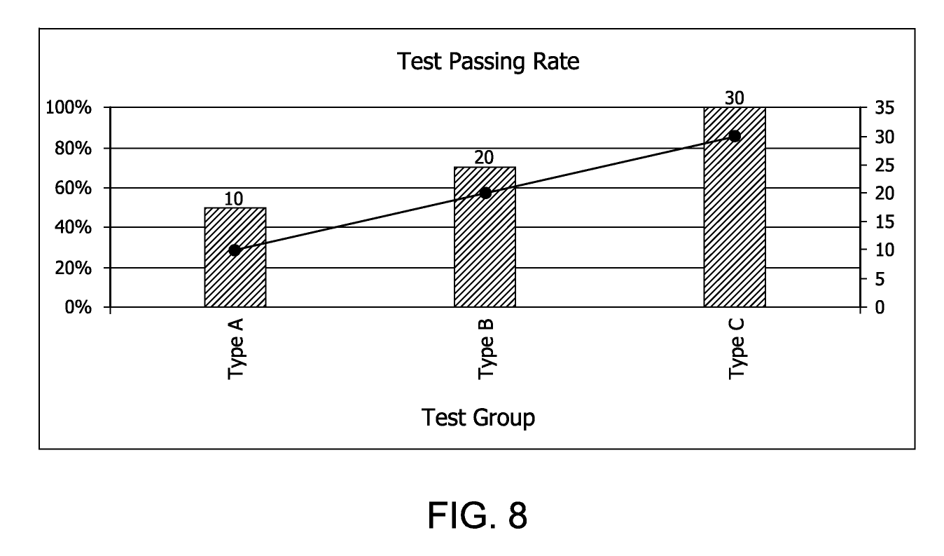

FIG. 8 is an example graphical display 800 of performance data from an automated performance verification method in accordance with some embodiments. Table 1 is an example tabular display of performance data from an automated performance verification method. There are three types of tests, type A, type B and type C. The functional pass ratio and performance pass ratio for each type is shown in FIG. 8 and Table 1.

TABLE 1

| | | Function | | | Performance | | |
|---|---|---|---|---|---|---|---|
| | No. of tests | fail | pass | ratio | fail | pass | ratio |
| Type A | 10 | 5 | 5 | 50.00% | 0 | 5 | 50.00% |
| Type B | 20 | 0 | 20 | 100.00% | 6 | 14 | 70.00% |
| Type C | 30 | 0 | 30 | 100.00% | 0 | 30 | 100.00% |
| Total | 60 | 5 | 55 | 91.67% | 6 | 49 | 81.67% |

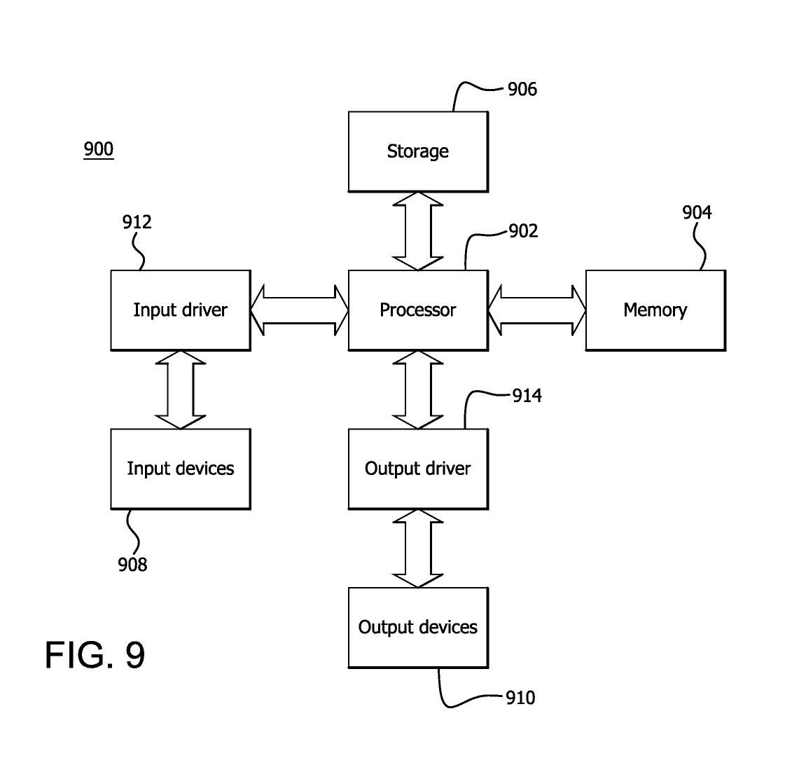

FIG. 9 is a block diagram of an example device 900 for which one or more disclosed embodiments may be implemented. The device 900 may include, for example, a computer, a gaming device, a handheld device, a set-top box, a television, a mobile phone, or a tablet computer. The device 900 includes a processor 902, a memory 904, a storage 906, one or more input devices 908, and one or more output devices 910. The device 900 may also optionally include an input driver 912 and an output driver 914. It is understood that the device 900 may include additional components not shown in FIG. 9.

The processor 902 may include a central processing unit (CPU), a graphics processing unit (GPU), a CPU and GPU located on the same die, or one or more processor cores, wherein each processor core may be a CPU or a GPU. The memory 904 may be located on the same die as the processor 902, or may be located separately from the processor 902. The memory 904 may include a volatile or non-volatile memory, for example, random access memory (RAM), dynamic RAM, or a cache.

The storage 906 may include a fixed or removable storage, for example, a hard disk drive, a solid state drive, an optical disk, or a flash drive. The input devices 908 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 910 may include a display, a speaker, a printer, a haptic feedback device, one or more lights, an antenna, or a network connection (e.g., a wireless local area network card for transmission and/or reception of wireless IEEE 802 signals).

The input driver 912 communicates with the processor 902 and the input devices 908, and permits the processor 902 to receive input from the input devices 908. The output driver 914 communicates with the processor 902 and the output devices 910, and permits the processor 902 to send output to the output devices 910. It is noted that the input driver 912 and the output driver 914 are optional components, and that the device 900 will operate in the same manner if the input driver 912 and the output driver 914 are not present.

In general and in accordance with some embodiments, a method for verifying performance of a unit in an integrated circuit is described herein. Design feature-specific performance tests are generated to meet expected performance goals that account for workloads, optimization techniques and different integrated circuit design configurations. A register transfer level (RTL) simulation is run using the performance tests to generate actual performance results. The actual performance results are then verified to meet the expected performance results. The verification includes performing a functional comparison between the actual performance results and the expected performance results, determining performance measurements based on the actual performance results, and analyzing the performance measurements. The actual performance results are published in a visual, organized format.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein, to the extent applicable, may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for verifying performance of a unit in an integrated circuit, comprising:
generating design feature-specific performance tests to meet expected performance goals that account for workloads, optimization techniques and different integrated circuit design configurations;
running, by using a processor, a register transfer level (RTL) simulation using the performance tests to generate actual performance results;
verifying, by using the processor, that the actual performance results meet expected performance results;
feeding back the actual performance results to adjust and update the feature-specific performance tests; and
publishing, on a display device, the actual performance results in a visual, organized format, wherein the running, verifying, feeding back and publishing are integrated into an automated verification infrastructure.

2. The method of claim 1, wherein the optimization techniques include at least one of padding a hull shader to avoid local data storage bank conflicts, not allowing a Shader seQuence Cache (SQC) request to split a cache, avoid having a primitive being sent to two Shader Engines and warming a cache for tests with virtual memory settings.

3. The method of claim 1, wherein verifying further comprises:
performing a functional comparison between the actual performance results and the expected performance results;
determining performance measurements based on the actual performance results; and
analyzing the performance measurements.

4. The method of claim 1, wherein the performance measurements include at least one of throughput, execution time, register settings, starve/stall values, workload balance values and latency values for memory devices.

5. The method of claim 3, wherein analyzing further comprises:
calculating a theoretical peak rate value for each performance measurement;
computing an actual peak rate data for each performance measurement; and
performing a comparison between the theoretical peak rate value and actual peak rate value for each performance measurement.

6. The method of claim 5, further comprising:
identifying a bottleneck performance measurement if the actual peak rate value does not meet the theoretical peak rate value.

7. The method of claim 6, further comprising:
analyzing a starve/stall value;
analyzing latency information;
verifying the bandwidth usage for memory devices;
checking workload balance for each unit; and
adjusting the performance tests based on an identified bottleneck.

8. The method of claim 3, wherein analyzing further comprises:
determining an achieved efficiency value by dividing an actual performance value by an expected theoretical value; and
passing the unit if the achieved efficiency value meets an expected efficiency value.

9. A device configured to verify performance of a unit in an integrated circuit, comprising:
a processor;
a display
the processor configured to generate design feature-specific performance tests to meet expected performance goals that account for workloads, optimization techniques and different integrated circuit design configurations;
the processor configured to run a register transfer level (RTL) simulation using the performance tests to generate actual performance results;
the processor configured to verify that the actual performance results meet expected performance results;
the processor configured to feedback the actual performance results to adjust and update the feature-specific performance tests; and
the processor configured to publish the actual performance results in a visual, organized format on the display on a condition that performance expectations are met, wherein running, verifying, feeding back and publishing are integrated into an automated verification infrastructure.

10. The device of claim 9, wherein the optimization techniques include at least one of padding a hull shader to avoid local data storage bank conflicts, not allowing a Shader seQuence Cache (SQC) request to split a cache, avoid having a primitive being sent to two Shader Engines and warming a cache for tests with virtual memory settings.

11. The device of claim 9, further comprising:
the processor configured to perform a functional comparison between the actual performance results and the expected performance results;
the processor configured to determine performance measurements based on the actual performance results; and
the processor configured to analyze the performance measurements.

12. The device of claim 9, wherein the performance measurements include at least one of throughput, execution time, register settings, starve/stall values, workload balance values and latency values for memory devices.

13. The device of claim 11, further comprising:
the processor configured to calculate a theoretical peak rate value for each performance measurement;
the processor configured to compute an actual peak rate data for each performance measurement; and
the processor configured to perform a comparison between the theoretical peak rate value and actual peak rate value for each performance measurement.

14. The device of claim 13, further comprising:
the processor configured to identify a bottleneck performance measurement if the actual peak rate value does not meet the theoretical peak rate value.

15. The device of claim 14, further comprising:
the processor configured to analyze a starve/stall value;
the processor configured to analyze latency information;
the processor configured to verify the bandwidth usage for memory devices;
the processor configured to check workload balance for each unit; and
the processor configured to adjust the performance tests based on an identified bottleneck.

16. The device of claim 13, further comprising:
the processor configured to determine an achieved efficiency value by dividing an actual performance value by an expected theoretical value; and
the processor configured to pass the unit if the achieved efficiency value meets an expected efficiency value.

17. A computer readable non-transitory medium including instructions which when executed in a processing system cause the processing system to execute a method for verifying performance of a unit in an integrated circuit, the method comprising the steps of:
generating design feature-specific performance tests to meet expected performance goals that account for workloads, optimization techniques and different integrated circuit design configurations;
running a register transfer level (RTL) simulation using the performance tests to generate actual performance results;
verifying that the actual performance results meet expected performance results;
feeding back the actual performance results to adjust and update the feature-specific performance tests; and
publishing the actual performance results in a visual, organized format on a condition that performance expectations are met, wherein the running, verifying and publishing are integrated into an automated verification infrastructure.

18. The method of claim 17, wherein the optimization techniques include at least one of padding a hull shader to avoid local data storage bank conflicts, not allowing a Shader seQuence Cache (SQC) request to split a cache, avoid having a primitive being sent to two Shader Engines and warming a cache for tests with virtual memory settings.

19. The method of claim 17, wherein verifying further comprises:
performing a functional comparison between the actual performance results and the expected performance results;
determining performance measurements based on the actual performance results; and
analyzing the performance measurements.

20. The method of claim 19, wherein analyzing further comprises:
calculating a theoretical peak rate value for each performance measurement;
computing an actual peak rate data for each performance measurement; and
performing a comparison between the theoretical peak rate value and actual peak rate value for each performance measurement.
